(19) United States
(12) Patent Application Publication
(10) Pub. No.: US 2019/0321994 A1
(43) Pub. Date: Oct. 24, 2019

(54) PET CLIPPERS HAVING HALO-ILLUMINATION LIGHTING

(71) Applicant: Naftoli Jacobowitz, Brooklyn, NY (US)

(72) Inventor: Naftoli Jacobowitz, Brooklyn, NY (US)

(21) Appl. No.: 16/390,306

(22) Filed: Apr. 22, 2019

Related U.S. Application Data
(60) Provisional application No. 62/660,952, filed on Apr. 21, 2018.

(51) Int. Cl. B26B 19/46; B26B 19/38; B26B 19/04; A01K 13/00

(52) U.S. Cl. CPC B26B 19/46; B26B 19/3886; B26B 19/3873; B26B 19/046; A01K 13/00; B26B 19/3846

(57) ABSTRACT

Disclosed is a pet clipper for clipping or trimming hair of pet animals, such as a dog or a cat, by providing adequate lighting via the same pet clipper during the hair clipping or trimming process. The lighting provides halo-illumination lighting effect such that a 360-degree light encircles a clipping or trimming surface of a pet animal during the hair clipping or trimming process. The use of halo-illumination allows a user to see the clipping or trimming surface of the pet animal more clearly and effectively, thus providing the user sufficient information as to whether they are performing a suitable job during the hair clipping or trimming process.

### CROSS-REFERENCE TO RELATED PATENT DOCUMENTS

This patent application claims the benefit of priority of U.S. Provisional Application No. 62/660,952, entitled “PET CLIPPERS HAVING HALO-ILLUMINATION LIGHTING,” filed Apr. 21, 2018, which are hereby incorporated herein by reference in its entirety.

### FIELD OF THE INVENTION

The present invention relates generally to handheld devices, and, more particularly, to a pet clipper device for a pet animal. The pet clipper device includes halo-illumination lighting that is used while clipping or trimming hair of the pet animal such as a dog.

### BACKGROUND

Grooming in the pet industry is a multi-billion dollar market. Grooming is an important part of caring for furry pets. Removing unwanted hair or detached hair, such as the loose hair from an animal's undercoat, is generally desirable. Particularly with dogs and cats, whose coats tend to molt or shed hair, a tool that can remove detached or almost detached hairs, while leaving live, secure ones in place, has become increasingly important to owners of such pets. Commensurate with grooming for cleanliness, many pet owners have taken to having their pet receive regular fur trimming for grooming and health purposes. Historically, the owners merely allowed their pet's fur to grow naturally, as well as shed naturally, in accordance with seasonal changes. However, with the advent of pet grooming, and education of pet owners, many owners have begun to understand the health benefits of keeping a pet's fur neatly trimmed Diseases that can occur within a pet's fur can include alopecia, anemia caused by fleas, tick infestation, and other diseases that may be hidden by a large amount of fur or in fact exacerbated by a large amount of fur.

While there are a variety of pet hair clippers in the market, a key problem with the current pet hair clippers is the lack of visibility they offer to pet owners and groomers (i.e., users) while clipping or trimming the hair of pet animals. In particular, amateurs and new users of the pet hair clippers are unable to get a ‘clean’ hands-on experience as they cut the fur of the pet animals. Thus, the end result is likely an uneven and unprofessional-looking haircut.

In light of the foregoing, there exists a need for a technical and reliable solution that solves the above-mentioned problems and presents an improved pet hair clipper device for pet animals.

### BRIEF SUMMARY

It is an objective of the present invention to provide a pet hair clipper for pet animals. The pet hair clipper of the present invention is highly efficient and appropriate for clipping or trimming hair of pet animals, such as a dog or a cat, by providing adequate lighting via the same pet hair clipper during the hair clipping or trimming process. In particular to the present invention, the lighting provides halo-illumination lighting effect such that a 360-degree light encircles a clipping or trimming surface of a pet animal (i.e., a specific area of a pet's fur) during the hair clipping or trimming process. The use of halo-illumination allows a user (such as a pet owner or groomer) to see the clipping or trimming surface (from where hair has to be removed or cut into small pieces) of the pet animal more clearly and effectively, thus providing the user sufficient information as to whether they are performing a suitable job during the hair clipping or trimming process.

Thus, the present invention addresses the problems associated with the current pet hair clippers in the market by providing a circular, more specifically, a halo-illuminating light capable of illuminating the specific area of the pet's fur while it is being trimmed. The present invention facilitates an effective and efficient hair clipping or trimming environment for the pet animals by avoiding the requirement of using multiple lights in order to avoid shadow areas over fur areas while the pet's fur is being trimmed.

The pet hair clipper of the present invention includes a clipper head comprised of a movable blade that reciprocates from side to side in close contact with one or more motors. Each motor used to drive the movable blade is preferably a silent or near-silent motor. The clipper head can include comb-cap with grooves to be inserted on the movable blades. The pet hair clipper further includes a base, wherein the base can, in one embodiment, include a textured surface to allow sufficient hand-hold of the pet hair clipper. The pet hair clipper further includes a lighting source that encircles the pet hair clipper to provide a halo-illuminating effect when in use. The lighting source that provides the halo-illuminating effect can be a light emitting diode (LED), incandescent light bulb, and the like. The lighting source can be a white light or a blue light.

In operating the pet hair clipper, an actuator button (such as a power switch) can be used to start (i.e., turn ON) the pet hair clipper. Further, an actuator button (such as a light source switch) can be used to turn ON the lighting source. In some example, the same actuator button can be used to start (i.e., turn ON) the pet hair clipper as well as turn ON the lighting source of the pet hair clipper. In one example, the pet hair clipper can be powered by an a/c source, such as a wall plug. In another example, the pet hair clipper can be powered by disposable batteries. In yet another example, the pet hair clipper can be powered by a rechargeable power source, for example, rechargeable batteries. In an embodiment, the pet hair clipper can be multi-speed, for example, dual speed, triple speed, or the like.

In an embodiment, the lighting source of the pet hair clipper facilitates the halo-illuminating effect. The lighting source, when actuated, provides a circular light that will encompass an aspect of the pet's fur to be trimmed. In such a manner, the user can sufficiently illuminate one or more desired areas of the pet's fur at the same time, thus avoiding the necessity to use multiple light sources, such as several flashlights.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 illustrates a front view of a pet hair clipper, in accordance with an embodiment of the present invention;

FIGS. 2 and 3 illustrate a bottom view and a top view of the pet hair clipper, in accordance with an embodiment of the present invention;

FIG. 4 illustrates a blown-up version of the pet hair clipper, in accordance with an embodiment of the present invention;

FIGS. 5 and 6 illustrate an inside view of the pet hair clipper as viewed from the front, in accordance with an embodiment of the present invention;

FIG. 7 illustrates a side perspective view of a blown version of the pet hair clipper, in accordance with an embodiment of the present invention;

FIG. 8 illustrates a top isometric view of a light panel of the pet hair clipper, in accordance with an embodiment of the present invention; and

FIG. 9 shows an exemplary scenario for illustrating the usage of the pet hair clipper for clipping a pet's fur, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a pet hair clipper for a pet animal such as dog or a cat. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, a pet hair clipper for clipping or trimming hair (or fur) of a pet animal, such as a dog or a cat. The pet hair clipper includes halo-illumination lighting that is used during the clipping or trimming of hair (or fur) of the pet animal such as a dog. As used herein, the term “illumination” refers to the use of a light source to spotlight a particular area or object of interest. The term “halo-illumination” refers to a light source capable of providing 360-degree lighting of an area or object at the same time, whereas the light is provided on the periphery of the exuded light, and the center of the light does not provide any light.

Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed systems and methods have been described above, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope.

The pet hair clipper having halo-illumination lighting will now be described with reference to the accompanying drawings, which should be regarded as merely illustrative without restricting the scope and ambit of the present invention.

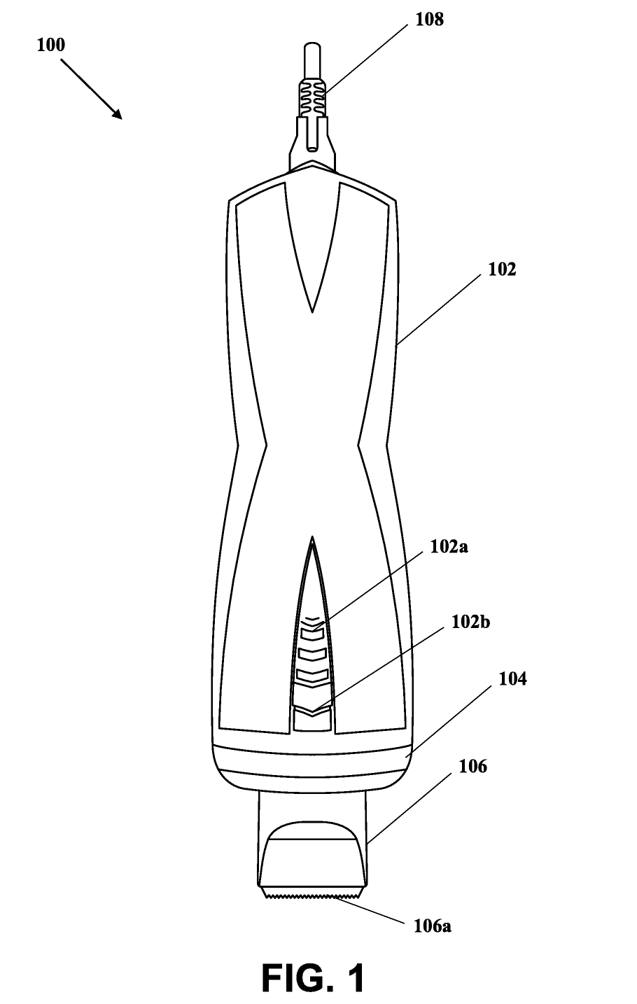

FIG. 1 illustrates a front view of a pet hair clipper 100, in accordance with an embodiment of the present invention. The pet hair clipper 100 includes a plurality of portions such as a body portion 102, a light source portion 104, and a clipper head portion 106. In an embodiment, the body portion 102, the light source portion 104, and the clipper head portion 106 are removably assembled or attached together to obtain the pet hair clipper 100.

In an embodiment, the body portion 102 (such as an upper body portion of the pet hair clipper 100) may be made of various materials, such as, but not limited to, plastic, aluminum, copper, steel or iron. The body portion 102 may include an actuator assembly such as a power switch assembly 102a on its top i.e., on a front part of the body portion 102 as shown in FIG. 1. The power switch assembly 102a may include at least one actuator button such as a power switch. The power switch may be an electrical switch, an electronic switch, a mechanical switch, or a combination thereof. In an exemplary embodiment, the power switch may be operated to activate or deactivate (i.e., to turn ON or turn OFF) the pet hair clipper 100. The power switch may also be operated to control the movement of a set of blades 106a included in a clipper head 106 of the pet hair clipper 100. The set of blades 106a reciprocates from side to side in close contact with one or more motors included inside the pet hair clipper 100. The power switch may be operated along three positions such as a first position, a second position, and a third position. In the first position of the power switch, the pet hair clipper 100 remains in OFF condition (i.e., in deactivated mode), and the set of blades 106a does not reciprocate. In the second position of the power switch, the pet hair clipper 100 is turned ON (i.e., in activated mode), and the set of blades 106a reciprocates, and operates at a medium speed. In the third position of the power switch, the pet hair clipper 100 remains turned ON, and the set of blades 106a reciprocates, and operates at a high speed. Thus, the power switch of the power switch assembly 102a may be operated by a user (such as a pet owner or a pet groomer) to switch between at least the first position, the second position, and the third position to operate the pet hair clipper 100. In another exemplary embodiment, the power switch assembly 102a may include three separate power switches such as a first power switch, a second power switch, and a third power switch. The first power switch may be operated to turn OFF the pet hair clipper 100. The second power switch may be operated to turn ON the pet hair clipper 100 in which the set of blades 106a operates and reciprocates at a medium speed in a synchronous manner. The third power switch may be operated to turn ON the pet hair clipper 100 and in which the set of blades 106a operates and reciprocates at a high speed in a synchronous manner.

In an embodiment, the body portion 102 may further include another actuator button such as a light source switch 102b on its top i.e., on a front part of the body portion 102 as shown in FIG. 1. The light source switch 102b may be an electrical switch, an electronic switch, a mechanical switch, or a combination thereof. The light source switch 102b may be operated by the user to turn ON or turn OFF a lighting source, such as one or more light emitting diodes (“LED's” or a series of LED's) included in the light source portion 104 of the pet hair clipper 100. The light source switch 102b may be associated with at least four modes of operations. Each mode of operation may be activated by pressing or operating the light source switch 102b. In one example, with a first press of the light source switch 102b by the user, a front half of the light source portion 104 is illuminated (i.e., turns ON) and emits halogen light by means of one or more LED's (i.e., the front half of a panel of LED's lights up). Further, with a second press of the light source switch 102b by the user, a rear half of the light source portion 104 is illuminated (i.e., turns ON) and emits halogen light by means of one or more LED's (i.e., the back half of a panel of LED's lights up). Further, with a third press of the light source switch 102b by the user, the entire light source portion 104 is illuminated (i.e., turns ON) and emits halogen light by means of one or more LED's (i.e., the entire panel of LED's lights up). Further, with a fourth press of the light source switch 102b by the user, the light source portion 104 is no longer illuminated (i.e. turns OFF) and does not emit halogen light from any of the one or more LED's. In other embodiments, the light source portion 104 may be comprised of other light emitting means, such as incandescent or fluorescent type light sources. In one embodiment of the present invention, the power switch 102a and the light source switch 102b may be realized and implemented using the same actuator button that has been designed and configured to turn ON-OFF the pet hair clipper 100 as well as the light source portion 104.

In an embodiment, the head clipper portion 106 (such as a lower body of the pet hair clipper 100) is designed to include the set of blades 106a of the pet hair clipper 100. The head clipper portion 106 can be from about 1″ to about 2″ in length. In one embodiment, the head clipper portion 106 is telescopic, allowing it to extend from one length to another as required during the clipping or trimming process of the pet's fur. The head clipper portion 106 may be made up of a plastic or metallic material. The head clipper portion 106 also includes the set of blades 106a that is removably (or permanently) attached with it. The set of blades 106a can be designed to fit with the head clipper portion 106. In one embodiment, each blade of the set of blades 106a is made up of hardened steel. The set of blades 106a includes one or more pairs of sharpened comb-like blades in close contact one above the other and the side which slide sideways relative to each other, a mechanism which may be manual or electrical to make the blades oscillate from side to side. Each blade is usually made of rust-resistant stainless steel. Ceramic cutters or blades may also be used. Ceramic blades are not subject to corrosion, and stay sharper longer because of a higher resistance to wear than metal blades. They remain cool to the touch even with fairly prolonged use, as ceramic is a poor heat conductor. However, ceramic blades are brittle and easily broken, and more expensive to replace than metal blades.

The set of blades 106a (or the head clipper portion 106 including the set of blades 106a) may be removable as well as replaceable. In an embodiment, the rotational speed or the oscillation of the set of blades 106a may be controlled by means of the one or more motors that are housed or positioned inside a pet hair clipper body portion (such as the body portion 102) of the pet hair clipper 100. The one or more motors may be removably positioned inside the pet hair clipper 100 to drive the set of blades 106a. For example, when the power switch of the power switch assembly 102a is turned ON (i.e., the power switch is at the second position or the third position), the one or more motors are also turned ON, which in turn reciprocates or oscillates the set of blades 106a from one side to another side. In an embodiment, the one or more motors may be configured to operate at two speeds i.e., at the medium speed and at the high speed. The speed of the one or more motors may be controlled by operating the power switch of the power switch assembly 102a. For example, when the power switch is at the second position or at the third position, the one or more motors are turned ON and accordingly operates at the defined medium speed or the defined high speed, which in turn reciprocates or oscillates the set of blades 106a at the medium speed or at the high speed.

In FIG. 1, there is further shown an electrical charging or operating cable such as a power chord 108 that may be removably fixed to an input power supply terminal of the pet hair clipper 100. The input power supply terminal may be located at the top of the pet hair clipper 100. In one example, the power chord 108 may be utilized by the user to charge at least one battery (not shown) housed or positioned with the pet hair clipper body portion (such as the body portion 102) of the pet hair clipper 100. When connected, the power chord 108 may draw an electrical power from a mains power supply (such as AC or DC power) and supply the drawn electrical power to the battery of the pet hair clipper 100 for charging the battery. Upon partial charging or complete charging of the battery of the pet hair clipper 100, the user may utilize the pet hair clipper 100 for clipping or trimming the pet's fur or hair. In another example, the power chord 108 may be utilized by the user to directly supply the electrical power from the mains power supply to the pet hair clipper 100, and the user may utilize the pet hair clipper 100 for clipping or trimming the pet's fur or hair. In another example, the power chord 108 may be utilized by the user for charging the battery of the pet hair clipper 100 and clipping or trimming the pet's fur or hair at the same time.

The body portion 102 may be designed such that the user can easily grasp and control the pet hair clipper 100. In one example, the body portion 102 is from 1″ to 3″ in diameter and 3″ to 5″ in length. The body portion 102 is tapered at its top to allow strong connection to the head clipper portion 106. In one embodiment, the body portion 102 contains a grip, allowing the user to securely hold the pet hair clipper 100 during the clipping or trimming process. An actuation button (i.e., the power switch of the power switch assembly 102a) is positioned on the body portion 102. In use, the power switch controls the ON-OFF mechanism of the pet hair clipper 100. When turned on, the set of blades 106a reciprocates or oscillates at the medium or high speed. The sideways reciprocation of the blades 106a may be utilized by the user to clip or trim the fur or hair of the pet animals such as a dog or a cat. Another actuation button (such as the light source switch 102b) controls the lighting source of the pet hair clipper 100, completing the internal circuit such that the lighting source turns ON to provide halo-illumination at the required area over the pet's body. As will be discussed later, the light source, when actuated, provides a halo-like illumination effect emanating from the pet hair clipper 100 onto the pet's body surface where hair or fur clipping is to be performed.

In an embodiment, the pet hair clipper 100 includes an axis along which a rear half of the body portion 102 is removably fixed to the front half of the body portion 102. In one example, the rear half of the body portion 102 may be removed from the front half of the body portion 102 to replace the battery or the one or more motors of the pet hair clipper 100. In another example, the rear half of the body portion 102 may be removed from the front half of the body portion 102 to perform maintenance work with respect to at least the battery or the one or more motors of the pet hair clipper 100.

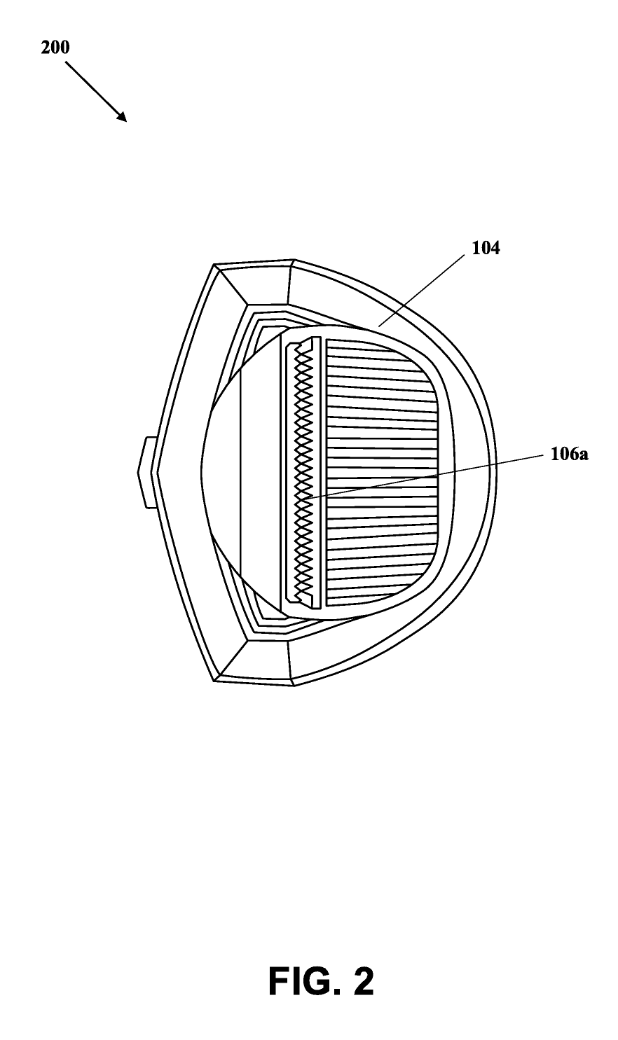

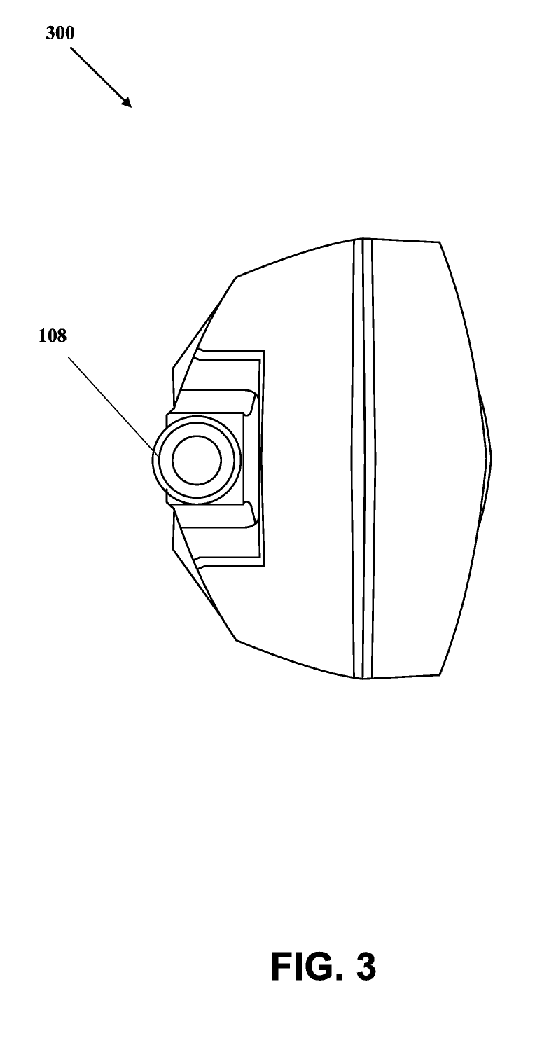

FIGS. 2 and 3 illustrate a bottom view 200 and a top view 300 of the pet hair clipper 100, in accordance with an embodiment of the present invention. In the top view 300 of the pet hair clipper 100 as shown in FIG. 3, the power chord 108 has been shown as removably fixed or attached to the input power supply terminal of the pet hair clipper 100. The other end of the power chord 108 may be connected to the mains power supply to provide electrical power to the battery of the pet hair clipper 100 for charging the battery or to the one or more motors of the pet hair clipper 100 for producing the rotational power, which in turn controls and manages the reciprocation or oscillation of the set of blades 106a.

In the bottom view 200 of the pet hair clipper 100 as shown in FIG. 2, the head clipper portion 106 has been shown that houses the set of blades 106a of the pet hair clipper 100. The set of blades 106a may be made of a stainless steel or a ceramic material. The set of blades 106a may the same grades of grit ranging from course to soft to buff. The head clipper portion 106 including the set of blades 106a may be removably (or permanently) fixed or attached to an inner connector of the pet hair clipper 100. When the one or more motors are tuned ON, an interior shaft housed inside the head clipper portion 106 (that is physically connected to a motor shaft of the one or more motors by means of one or more internal channels) starts rotating or oscillating. The interior shaft housed inside the head clipper portion 106 is rotatably attached or connected to the set of blades 106a, and thus, as the interior shaft rotates, the set of blades 106a may reciprocate or oscillate, and hence, the pet hair clipper 100 can be used for clipping or trimming the fur or hair of the pet animal such as a pet dog or a pet cat. In one embodiment, the direction of reciprocation of the set of blades 106a may be sideways such that they are able to cut the fur or hair. In another embodiment, the direction of reciprocation of the set of blades 106a may be proportional to the rotation or reciprocation of the motor shaft. For example, if a motor shaft of a motor is rotating in clockwise direction, then the set of blades 106a may reciprocate in the clockwise direction. Similarly, if a motor shaft of a motor is rotating in anti-clockwise direction, then the set of blades 106a may reciprocate in the anti-clockwise direction. Also, if a motor shaft of a motor is reciprocating in sideways direction from one side to another side, then the set of blades 106a may reciprocate in the same manner. Alternatively, the pet hair clipper 100 may include a reciprocation controlling switch (not shown) that may be operated by the user to control the direction of reciprocation or rotation of the set of blades 106a. Alternatively, the set of blades 106a may uniformly rotate in all direction due to the rotation of the motor shaft of the motor.

In operation, the power switch of the power switch assembly 102a may be operated by the user to activate or deactivate (i.e., turn ON or turn OFF) the pet hair clipper 100. For example, the pet hair clipper 100 is in OFF state when the power switch is in the first position. In the first position, there is no power supply to the one or more motors of the pet hair clipper 100. Thus, the one or more motors are in OFF state. As a result, the pet hair clipper 100 does not operate and the set of blades 106a does not reciprocate or oscillate or rotate. In the second position, the power is being drawn either from the battery or the mains power supply and the drawn power is supplied to the one or more motors of the pet hair clipper 100. Thus, the one or more motors are in ON state. As a result, the pet hair clipper 100 is turned ON and the set of blades 106a reciprocates or oscillates or rotates at the medium speed. In the third position, the power is being drawn either from the battery or the mains power supply and the drawn power is supplied to the one or more motors of the pet hair clipper 100. Thus, the one or more motors are in ON state. As a result, the pet hair clipper 100 is turned ON or remains in the ON state, and the set of blades 106a reciprocates or oscillates or rotates at the high speed. During the operation of the pet hair clipper 100, the set of blades 106a may start rotating or reciprocating or oscillating either in the sideways direction, the clockwise direction, or the anti-clockwise direction. When the set of blades 106a is rotating or reciprocating or oscillating, the user may use the pet hair clipper 100 for clipping to trimming the hair or fur of the pet animal.

In an embodiment, the pet hair clipper 100 further includes the light source switch 102b that may be operated by the user to turn ON or turn OFF one or more LED's included in the light source portion 104. There are four modes of operating the light source switch 102b. In a first mode, when the light source switch 102b is pressed by the user, the front half of the light source portion 104 emits halogen light such as by means of one or more halogen light emitting LED's. In a second mode, when the light source switch 102b is pressed by the user, the rear half of the light source portion 104 emits halogen light such as by means of one or more halogen light emitting LED's. In a third mode, when the light source switch 102b is pressed by the user, the entire light source portion 104 emits light from all sides or directions such as by means of one or more halogen light emitting LED's. In a fourth mode, when the light source switch 102b is pressed by the user, all of the LED's (such as all of the halogen light emitting LED's) are turned OFF and do not emit any light.

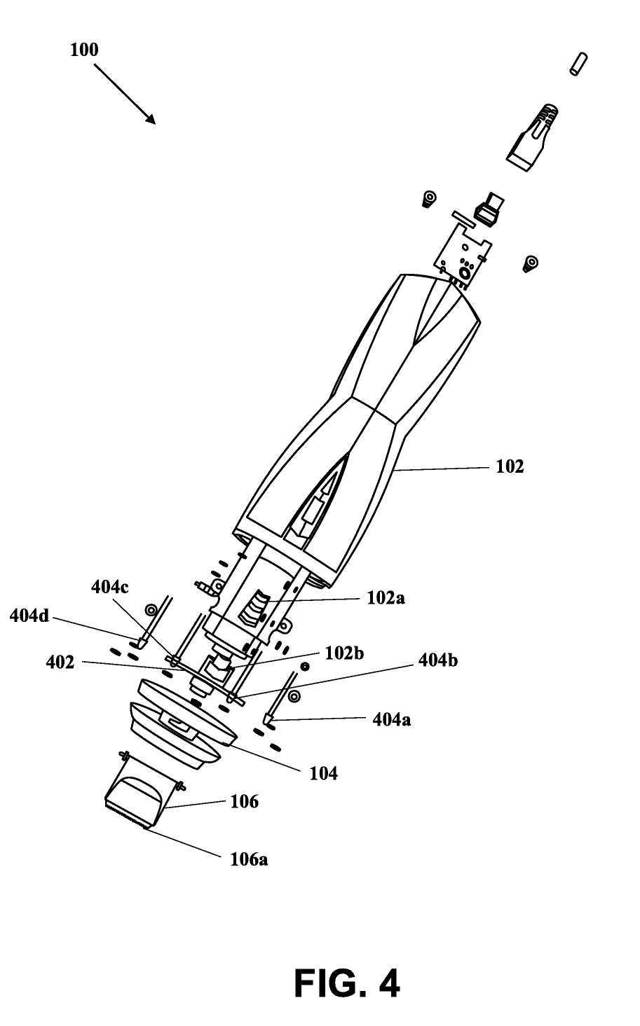

FIG. 4 illustrates a blown-up version of the pet hair clipper 100, in accordance with an embodiment of the present invention. The pet hair clipper 100 of FIG. 4 shows various components, for example, the body portion 102, the power switch assembly 102a, the light source switch 102b, the light source portion 104, the head clipper portion 106, and the set of blades 106a. The pet hair clipper 100 of FIG. 4 further shows an LED panel 402 and LED's 404a-404d. In an embodiment, the LED panel 402 may be used for holding the LED's 404a-404d. For example, the LED's 404a-404d are removably inserted into appropriate LED holes provided on the LED panel 402. Further, input terminals of each of the LED's 404a-404d are connected to a power supply unit such as the battery of the pet hair clipper 100. The ON-OFF of each of the LED's 404a-404d may be associated with one or more modes of operation of the light source switch 102b. For example, in the first mode of the light source switch 102b, only few of the LED's 404a-404d such as the LED's 404b and 404c are turned ON and thus the front half of the LED panel 402 (including the LED's 404b and 404c) is lighted. In the second mode of the light source switch 102b, only few of the LED's 404a-404d such as the LED's 404a and 404d are turned ON and thus the rear half of the LED panel 402 (including the LED's 404a and 404d) is lighted. In the third mode of the light source switch 102b, all of the LED's 404a-404d are turned ON and thus the entire LED panel 402 (including the LED's 404a-404d) is lighted. In the fourth mode of the light source switch 102b, all of the LED's 404a-404d are turned OFF and thus the entire LED panel 402 (including the LED's 404a-404d) does not emit light.

In an embodiment, the LED panel 402 also includes an opening at its center that allows a motor shaft of a motor (positioned inside the pet hair clipper 100) to pass through it and makes a contact with a cylindrical metallic material (such as a cylindrical brass pin, a cylindrical stainless-steel pin, or any other appropriate material). For example, the motor shaft of the motor makes a physical contact with a first brass pin included inside the pet hair clipper 100. The first brass pin further makes another physical contact with a second brass pin included inside the pet hair clipper 100. The head clipper portion 106 including the set of blades 106a is removably attached (or removably makes physical contact) with the second brass pin. Thus, when the motor is turned ON, the motor shaft of the motor rotates or reciprocates, which in turn rotates or reciprocates the first brass pin and the second brass pin. Due to the rotational or reciprocation motion of the second brass pin, the set of blades 106a also rotates or reciprocates. Due to the rotation or reciprocation of the set of blades 106a and/or the physical contact of the set of blades 106a with the second brass pin during the rotation or reciprocation, the oscillation or reciprocation in the set of blades 106a may be produced or generated. Thus, the set of blades 106a may vibrate or reciprocates from one side to another side. Such reciprocation of the set of blades 106a may be utilized for clipping or trimming the fur or hair of the pet animals. In one example, the set of blades 106a only rotates along its axis and is used for clipping or trimming the fur or hair of the pet animals. In another example, the set of blades 106a only vibrates or reciprocates from one side to another side and is used for clipping or trimming the fur or hair of the pet animals. In yet another example, the set of blades 106a reciprocates as well as vibrates and is used for clipping or trimming the fur or hair of the pet animals.

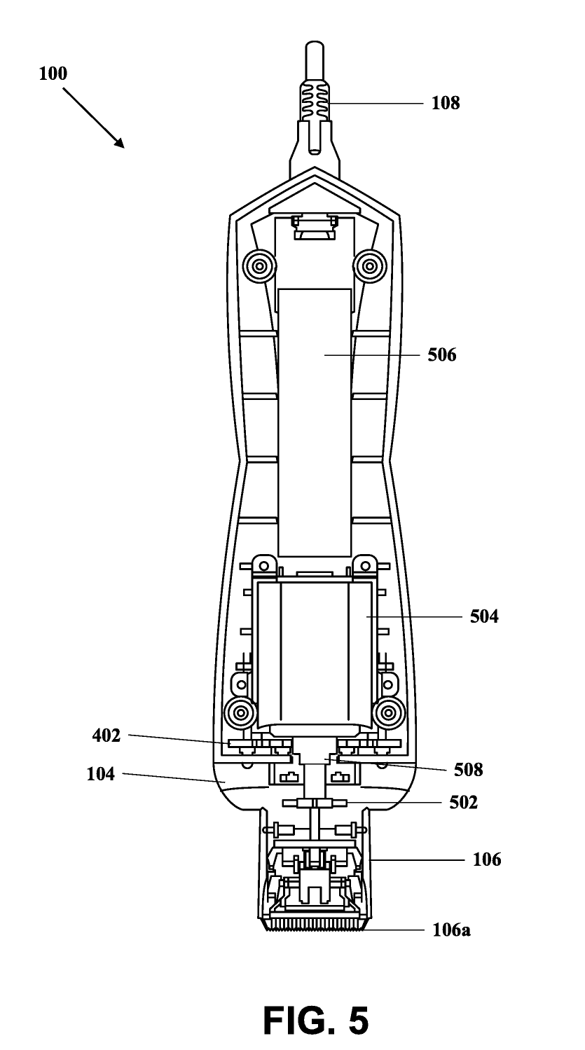

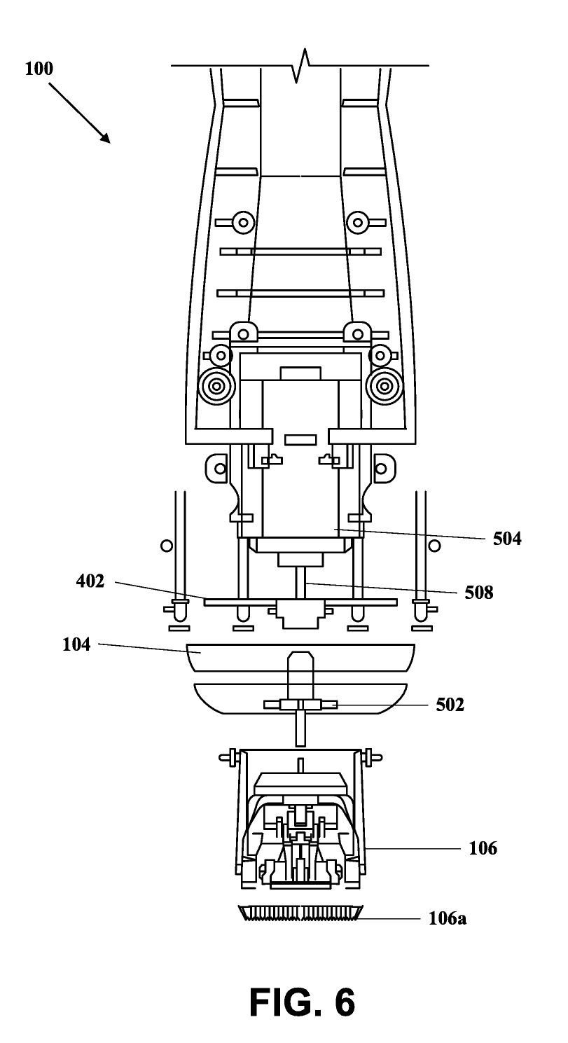

FIGS. 5 and 6 illustrate an inside view of the pet hair clipper 100 as viewed from the front, in accordance with an embodiment of the present invention. In FIGS. 5 and 6, there is shown the light source portion 104, the head clipper portion 106, the set of blades 106a, and the power chord 108. There is further shown a clip 502, the motor 504, the battery 506, and the motor shaft 508. The clip 502 includes at least the first brass pin and/or second brass pin. One end of the clip 502 is connected to the motor shaft 508, and another end of the clip 502 is connected to the set of blades 106a. As shown, the motor 504 and the battery 506 are housed inside the pet hair clipper 100. The motor 504 may be powered by the battery 506. The motor shaft 508 makes a contact with a cylindrical metallic material (such as a cylindrical brass pin, a cylindrical stainless-steel pin, or any other appropriate material) such as the clip 502. For example, the motor shaft 508 of the motor 504 makes a physical contact with the first brass pin included inside the pet hair clipper 100. The first brass pin further makes another physical contact with the second brass pin included inside the pet hair clipper 100. The set of blades 106a is removably attached (or removably makes physical contact alone, or via one or more other mechanical components) with the second brass pin. Thus, when the motor 504 is turned ON, the motor shaft 508 of the motor 504 rotates, which in turn rotates the first brass pin and the second brass pin. Due to rotational motion of the second brass pin, the set of blades 106a reciprocates or oscillates or rotates.

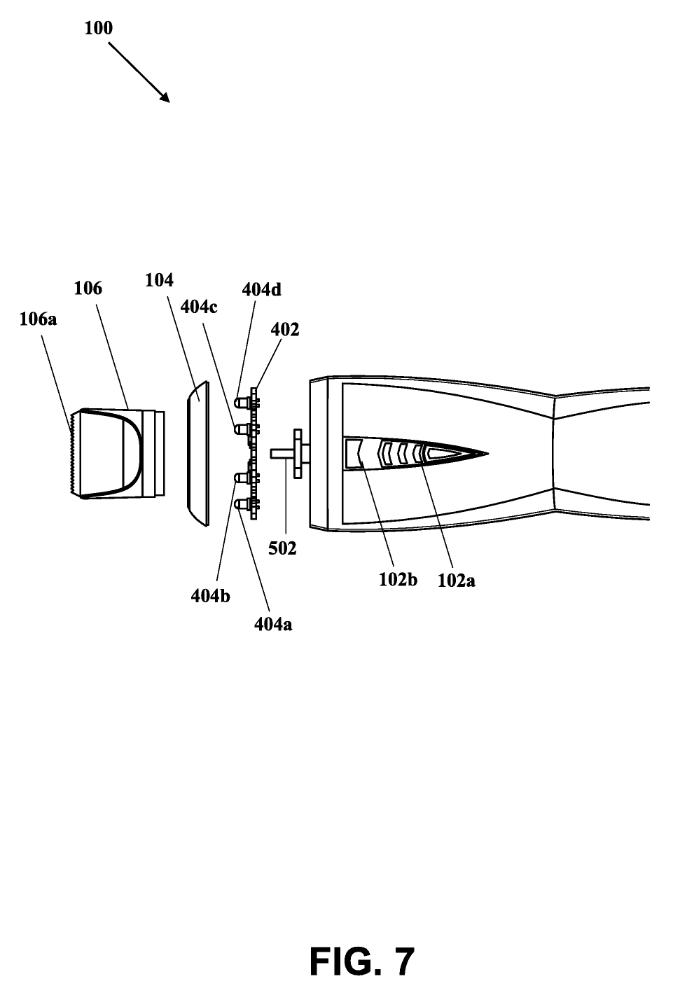

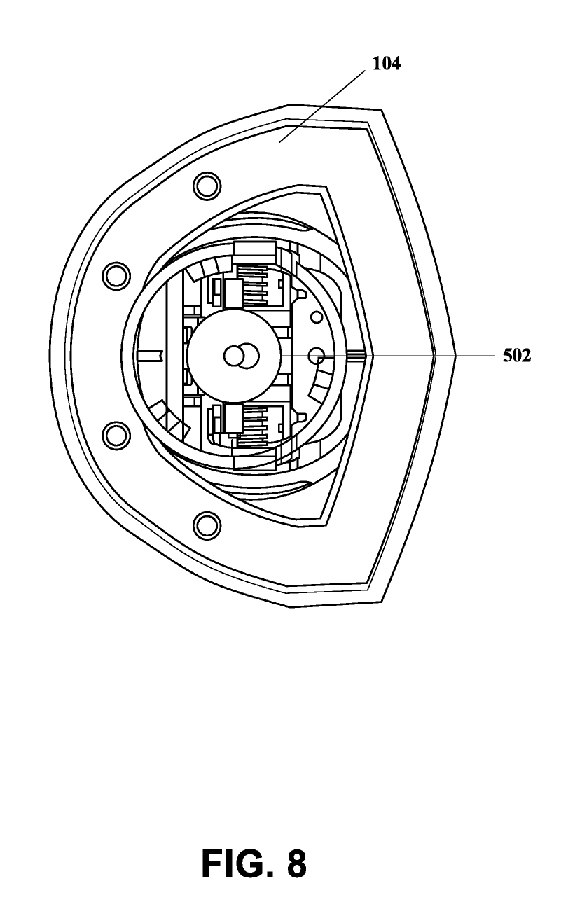

FIG. 7 illustrates a side perspective view of a blown version of the pet hair clipper 100, in accordance with an embodiment of the present invention. The clip 502 is metallic pin such as a brass pin having two ends such as the first brass pin and the second brass pin. The first brass pin connects is removably attached to the motor shaft 508 of the motor 504. The second brass pin is removably attached or connected to the set of blades 106a. The second brass pin of the clip 502 passes through the center of the LED panel 402. Thus, when the motor 504 rotates or reciprocates or oscillates, the set of blades 106a also rotates or reciprocates or oscillates. FIG. 8 illustrates a top isometric view of a light panel of the pet hair clipper 100, in accordance with an embodiment of the present invention. The halo-illumination of the lighting source (such as the light source portion 104 including the LED's 404a-404d) of the pet hair clipper 100 may be realized. When turned on via the light source switch 102b, the lighting source encircles the pet hair clipper 100 and highlights the desired surface area of the pet's body where the user wants to clip or trim the hair or fur. The lighting source that provides the halo-illuminating effect can be the LED's 404a-404d, incandescent light bulb, and the like. The lighting source can be a white light or a blue light.

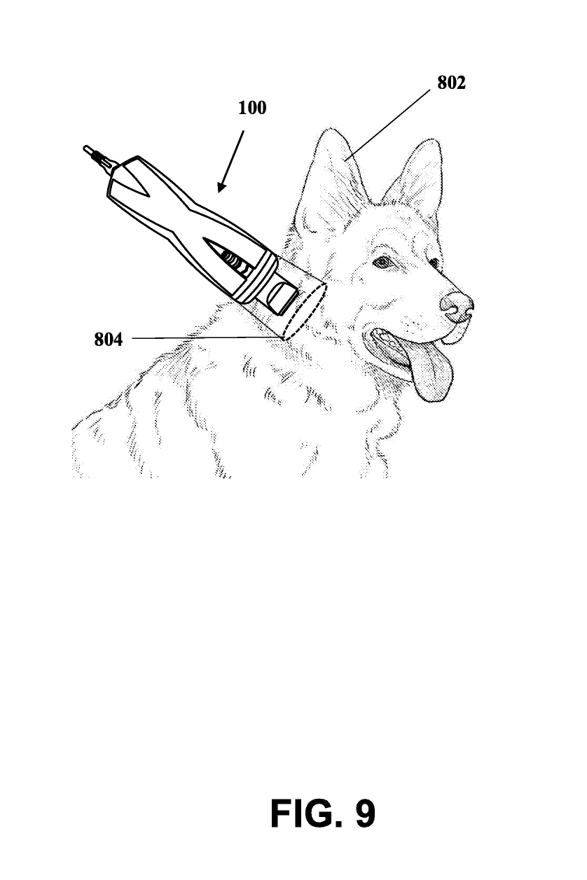

FIG. 9 shows an exemplary scenario for illustrating the usage of the pet hair clipper 100 for clipping a pet's fur, in accordance with an embodiment of the present invention. FIG. 8 shows the pet hair clipper 100 as used for clipping or trimming fur or hair of a pet dog 802. The pet's fur or hair is being trimmed by the pet hair clipper 100 of the present invention. In use, a user will first actuate the power switch on the pet hair clipper 100. Actuation will begin the slide to slide action of the clippers. Actuation will also turn on the lighting means, which will deliver a halo-illumination effect 804, highlighting a portion of the pet's fur while trimming is being performed. Through the various features, including the halo-illumination from the lighting source, an owner can not only gain access to all areas of the pet's body for trimming or clipping, but also has sufficient visibility to those areas. Specific to the invention, the lighting source is used to provide the halo-illumination lighting effect.

Although particular embodiments of the invention have been described in detail for purposes of illustration, various modifications and enhancements may be made without departing from the spirit and scope of the invention.

What is claimed is:

1. A pet clipper (100) for clipping fur of a pet animal, comprising:
a body portion (102), having at least one power switch (102a) and at least one light source switch (102b),
a light source portion (104) for providing halo-illumination lighting, and
a head clipper portion (106) having at least one set of blades (106a);
wherein said at least one power switch (102a) having at least three switch positions for controlling speed of reciprocation of said at least one set of blades (106a) of said pet clipper (100), and
said at least one light source switch (102b) having at least four modes for controlling illumination of said halo-illumination lighting that is used during clipping of said fur of said pet animal.

2. The pet clipper (100) of claim 1, wherein said at least one power switch (102a), having a first position for switching off said at least one set of blades (106a) such that said at least one set of blades (106a) is in a motionless state, a second position for switching on said at least one set of blades (106a) such that said at least one set of blades (106a) operates at a medium speed, and a third position for switching on said at least one set of blades (106a) such that said at least one set of blades (106a) operates at a high speed.

3. The pet clipper (100) of claim 1, wherein said at least one light source switch (102b) having said at least four modes for controlling illumination of said light source portion (104) of said pet clipper (100), wherein a first mode illuminates one or more LED's located within a front half of said light source portion (104), a second mode illuminates one or more LED's located within a rear half of said light source portion (104), a third mode illuminates one or more LED's in both front and rear halves of said light source portion (104), and a fourth mode deactivates all LED's in said light source portion (104).

4. The pet clipper (100) of claim 1, wherein said at least one power switch (102a) and said at least one light source switch (102b) are included on a front surface of an upper body portion of said body portion (102) of said pet clipper (100).

5. The pet clipper (100) of claim 3, wherein said front half of said light source portion (104) comprises at least one halogen light emitting LED that is turned on when said at least one light source switch (102b) is in said first mode.

6. The pet clipper (100) of claim 3, wherein said rear half of said light source portion (104) comprises at least one halogen light emitting LED that is turned on when said at least one light source switch (102b) is in said second mode.

7. The pet clipper (100) of claim 3, wherein an entire light source portion (104) comprises one or more halogen light emitting LED's that are turned on when said at least one light source switch (102b) is in said third mode.

8. The pet clipper (100) of claim 3, wherein an entire light source portion (104) comprises one or more halogen light emitting LED's that are turned off when said at least one light source switch (102b) is in said fourth mode.

9. The pet clipper (100) of claim 1, wherein at least one set of blades (106a) is removably fixed or attached to said head clipper portion (106), such that said at least one set of blades (106a) may be removed and replaced with another set of blades.

10. The pet clipper (100) of claim 1, wherein said light source portion (104) is positioned between an upper body portion (102) of said pet clipper (100) and said head clipper portion (106) of said pet clipper (100), and wherein said head clipper portion (106) includes a shaft that is removably connected to least one set of blades (106a).

11. The pet clipper (100) of claim 1, wherein said at least one set of blades (106a) is driven by means of at least one motor (504) positioned inside said pet clipper (100) body portion (102), and wherein said at least one motor (504) is powered by a battery (506) also positioned within said pet clipper (100) body portion (102).

12. The pet clipper (100) of claim 1, wherein said at least one set of blades (106a) is driven by means of at least one motor (504) positioned inside said pet clipper (100) body portion (102), and wherein said at least one motor (504) is powered by an external power supply connected to said at least one motor (504) by means of a power chord (108).
